(19) United States
(12) Patent Application Publication
(10) Pub. No.: US 2010/0092748 A1
(43) Pub. Date: Apr. 15, 2010

(54) METHOD OF MANUFACTURING ALUMINIUM NITRIDE

(75) Inventors: Matthieu Boehm, Voiron (FR); Alexandre Dessainjean, Voiron (FR); Jean-Remi Butruille, Montbonnot Saint Martin (FR)

Correspondence Address: BANNER & WITCOFF, LTD., 1100 13th STREET, N.W., SUITE 1200, WASHINGTON, DC, 20005-4051, US

(73) Assignee: ALCAN INTERNATIONAL LIMITED, Montreal, QC (CA)

(21) Appl. No.: 12/444,022

(22) PCT Filed: Aug. 3, 2007
(86) PCT No.: PCT/FR2007/001342

§ 371 Date: Nov. 24, 2009

(30) Foreign Application Priority Data
Oct. 16, 2006 (FR) 0609040

(51) Int. Cl. B32B 5/00; C01B 21/072; B32B 9/04; B32B 5/16

(52) U.S. Cl. 428/220; 423/412; 428/698; 428/402

(57) ABSTRACT

The invention relates to a method of manufacturing aluminium nitride, in which a multilayer structure including rolled aluminium-based products is prepared by stacking or winding, and it is heated under a nitrogenous atmosphere, the majority of the nitriding occurring during a phase in which the temperature of the nitrogenous atmosphere is maintained between 400° C. and 660° C. The invention makes it possible to obtain aluminium nitride via an economic method requiring neither the use of aluminium powder as a raw material nor the use of very high temperatures. The aluminium nitride obtained includes particles the microscopic structure of which is layered.

### FIELD OF THE INVENTION

The invention relates to a method of manufacturing aluminium nitride in the form of powders or wafers.

### PRIOR ART

Aluminium nitride is a ceramic which has an exceptionally high thermal conductivity outclassed only by beryllia. This property, which is associated with a high volume resistivity and dielectric constant, makes aluminium nitride a substrate of choice for assembling microelectronic components, the power and density of which increases steadily.

However, the use of an aluminium nitride substrate remains limited, in particular because of the high price for this ceramic, resulting from a prohibitive manufacturing cost. Thus, to date, the applications have been primarily limited to the military field.

Numerous methods exist for manufacturing aluminium nitride. The most common are the reduction of alumina via carbothermy under nitrogen and direct nitriding of aluminium powders.

In the reduction of alumina via carbothermy, a high-purity alumina is reduced to aluminium at a very high temperature (1700-1900° C.) and the aluminium formed is transformed into nitride according to the reaction:

Al₂O₃+3C+N₂=2AlN+3CO (1)

This method results in an aluminium nitride generally containing significant quantities of carbon and oxygen. Furthermore, the transformation conditions are costly.

The patent application FR 2 715 169 (Elf Atochem) thus discloses a method for manufacturing aluminium nitride macrocrystals in the form of wafers obtained via carbonitriding of alpha-alumina in the form of wafers, in the presence of carbon and nitrogen.

Direct nitriding of aluminium powder makes it possible to obtain a ceramic of considerable purity, however it requires the handling of extremely explosive fine aluminium powders. Furthermore, the nitriding reaction

2Al+N₂=2AlN (2)

is highly exothermic and causes the aluminium powder to melt, which has the disadvantage of producing aggregates stopping the reaction. It is therefore difficult to obtain a complete conversion.

The patent U.S. Pat. No. 5,710,382 (Dow Chemical) thus discloses a combustion method in which an aluminium powder mixed with a diluent, a ceramic, carbon or other products is transformed into aluminium nitride in various forms. The ignition temperature is typically 1050° C., and the maximum temperature can reach more than 2000° C.

Several attempts to improve the method of transforming metallic aluminium powder are presented in the prior art.

The patent applications EP 1 310 455 and EP 1 394 107 (Ibaragi Lab) disclose methods of nitriding aluminium powders under nitrogen pressure of between 105 and 305 kPa at a temperature of between 500 and 1000° C. These methods require delicate handling of aluminium powders.

The patent applications JP 9 012 308 and EP 0 887 308 (Toyota) disclose a method in which a mixture of aluminium powder and scrap aluminium having a diameter of between 0.1 and 5 mm is nitrided at a temperature of between 500 and 1000° C. The aluminium powder is an indispensable initiator for this method. The presence of magnesium alloys, which serves as an oxygen trap, promotes the reaction but probably has a negative impact on the purity of the nitrides obtained.

The patent application EP 0 494 129 (Pechiney Electrométallurgie) discloses a high-temperature method of nitriding a metallic powder in which the metallic powder is mixed with a refractory powder, which makes it possible to carry out the nitriding at a high temperature without any visible melting of the metallic powder.

The problem that this invention seeks to resolve is the obtainment of aluminium nitride, notably in the shape of a high purity powder, via an economical method requiring neither the use of aluminium powder as a raw material nor the use of very high temperatures.

### OBJECT OF THE INVENTION

A first object of the invention is a method of manufacturing aluminium nitride in which

(i) a multilayer structure is prepared via stacking or winding, including N layers consisting of aluminium-based rolled products, separated by N−1 interstitial spaces, N being at least equal to 10, the average mass density of the multilayer structure being controlled so as to be between 0.4 and 2 g/cm³, the interstitial spaces being open so as to enable a gas to flow into said interstitial spaces,

(ii) said multilayer structure is heated under a nitrogenous atmosphere, the thermal heating cycle including at least one phase in which the temperature of the nitrogenous atmosphere is maintained between 400° C. and 660° C., and during which the majority of the nitriding occurs.

Another object of the invention is an aluminium nitride wafer capable of being obtained by the method according to the invention, characterised in that its microscopic structure is layered.

Yet another object of the invention is an aluminium nitride powder capable of being obtained by the method according to the invention, including particles the microscopic structure of which is layered.

Yet another object of the invention is a micronised aluminium nitride powder the median particle size D50 of which is smaller than 1 μm, and preferably smaller than 0.7 μm, and the ratio D90/D10 of which is lower than 8 and preferably lower than 6.

### DESCRIPTION OF THE FIGURES

FIG. 1: stack of rolled products used within the scope of the invention.

FIG. 2: coil used within the scope of the invention.

FIG. 3: relationship obtained between the average mass density of the multilayer structures and the nitriding rate.

FIG. 4: the X-ray spectrum for the powder obtained.

FIG. 5: 5a: microscopic observation of the aluminium nitride powder obtained. 5b: schematic representation of FIG. 5a, showing a layered structure.

FIG. 6: particle-size distribution of a micronised aluminum nitride powder obtained.

### DESCRIPTION OF THE INVENTION

The chemical composition of standardised aluminium alloys is defined, for example, in the standard EN 573-3.

Unless otherwise specified, the definitions of the European standard EN 12258-1 apply. The terms related to scrap and the recycling thereof are described in the standard EN 12258-3.

The method according to the invention includes at least two steps. In a first step, a multilayer structure, having a controlled average mass density, including N layers consisting of aluminium-based rolled products, separated by N−1 interstitial spaces, N being at least equal to 10, is prepared via stacking or winding. Aluminium-based rolled products have a rectangular cross section. Preferably, N is at least equal to 50.

The interstitial spaces are open so as to enable a gas to flow into said interstitial spaces.

The average mass density of the multilayer structure is equal to the ratio between its mass and its volume, and it is generally lower than or equal to the average density of the rolled products used.

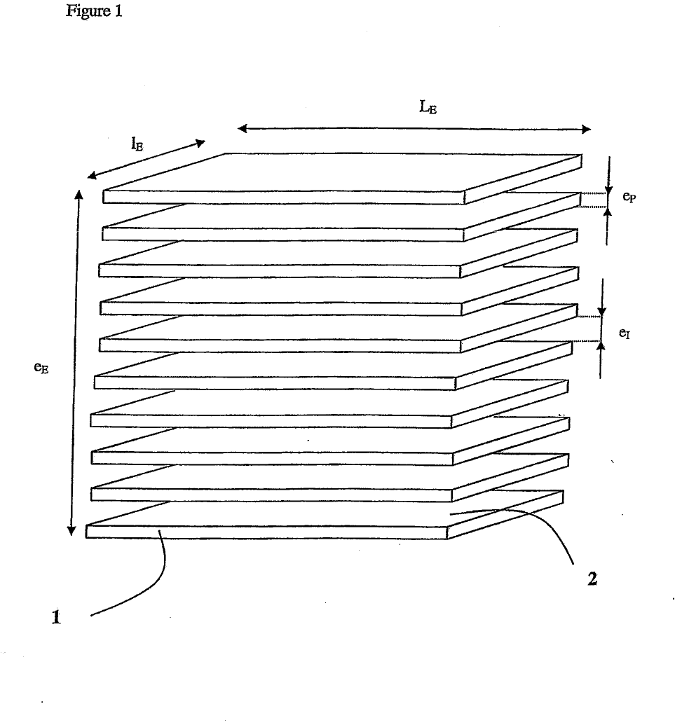

A first exemplary multilayer structure made within the scope of the invention is a stack of rolled products as shown in FIG. 1. In this embodiment, N layers of rolled products 1 of substantially identical dimensions are stacked on top of one another, each layer being separated from the following one by an interstitial space of average thickness e_{I} 2. The geometric parameters of a stack as defined within the scope of the invention are the length L_{E}, the width l_{E}, less than or equal to the length, and the thickness e_{E} in the direction perpendicular to the substantially parallel planes defined by the rolled products. A stack of rolled products thus includes N rolled products of substantially identical dimensions separated by N−1 interstitial spaces. The average mass density of the stack is the ratio between its mass and its volume V_{E}.

V_{E}=L_{E}·l_{E}·e_{E}.

If ē_{P} is said to be the average of the thicknesses eₚ of the rolled products and ē_{I} is the average of the average thicknesses e_{I} of the interstitial spaces, then the following relationship exists:

e_{E}=N·ē_{P}+(N−1)·ē_{I}.

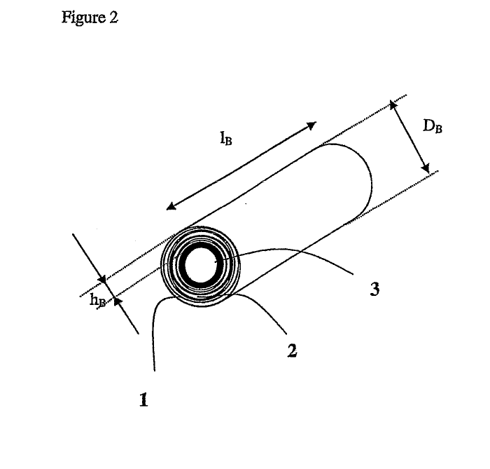

A second exemplary multilayer structure according to the invention is a coil obtained by cylindrical winding of a rolled product of substantially constant width such as that shown in FIG. 2. The geometric parameters of the coil are the width l_{B}, the diameter D_{B} and the height of the coiling h_{B}. Each turn of the winding constitutes one layer or turn 1. The turns are separated by an interstitial space of average thickness e_{I} 2. A coil of rolled products thus includes N turns of rolled products separated by N−1 interstitial spaces of average thickness e_{I}. The coil can be wound round a winding cylinder 3, made of steel for example, but the coil is preferably wound round a retractable cylinder which is removed prior to nitriding. The average mass density of the coil is the ratio between its mass (minus that of the winding cylinder, if there is one) and its volume V_{B} equal to

V_{B}=(3.14·(D_{B}²−(D_{B}−2 h_{B})²)/4)·l_{B}

If ē_{P} is said to be the average of the thicknesses eₚ of the turns and ē_{I} is the average of the average thicknesses e_{I} of the interstitial spaces, then the following relationship exists:

h_{B}=N·ē_{P}+(N−1)·ē_{I}

Substantially two factors can cause the average mass density of the multilayer structures to vary: the mass density of the rolled products and the average thickness of the interstitial space. The mass density of the rolled aluminium products used can vary significantly when said rolled products are etched. Thus rolled products having undergone an electrochemical etching operation such as that carried out in the aluminium capacitor industry can have a mass density possibly amounting to 30% less than that of solid aluminium products of a similar dimension.

The interstitial space has a complex shape: at certain locations, the successive layers can be in contact and, at other locations, separated by a space of a given thickness. The average thickness of an interstitial space, e_{I}, is a parameter making it possible to describe this interstitial space. A more complete description of the interstitial space might also include information about the shape of the interstitial space, in particular such as the surface density of the points of contact, the standard deviation of the average thickness, and the maximum thickness of the interstitial space, however this information is not essential within the scope of the invention.

The average thickness of each interstitial space of multilayer structures prepared via stacking or winding is advantageously controlled. Controlling the average thickness of the interstitial space can be carried out in various ways: for example, the roughness of the rolled products can be controlled or preferably ceramic and/or metallic particles serving to space apart the rolled products can be placed inside at least one interstitial space. The particles capable of being used to space apart the rolled products so as to control the average thickness of the interstitial space of the multilayer structures are advantageously metallic and/or ceramic particles which contain aluminium. These particles are preferably ceramic particles containing aluminium nitride. The morphology and the size of the particles capable of being used for controlling the average thickness of the interstitial space can influence the nitriding rate. The dimensions of the particles used are preferably of the order of a millimetre. In one advantageous embodiment of the invention, the particles used are flakes, i.e., their length and/or their width is approximately ten times greater than their thickness.

In the case of stacks, pressure can be exerted on the stack by means of metal plates, for example, in order to control the average thickness of the interstitial space. In the case of coils, the average thickness of the interstitial space can be controlled during winding, by acting on the winding parameters which, in the example of a new coil being obtained by winding an initial coil (“trans-winding”), are the tractive force exerted on the winding side of the new coil and the holding force exerted on the unwinding side of the initial coil.

In order for the rate obtained during the nitriding reaction to be industrially advantageous, the average mass density of the multilayer structure must be between 0.4 g/cm³ and 2 g/cm³. The average mass density of the multilayer structure is preferably greater than 0.6 g/cm³ and preferably greater than 0.8 g/cm³ and less than 1.8 g/cm³ and preferably less than 1.4 g/cm³. The uniformity of the mass density within the multilayer structures can influence the nitriding rate obtained, and it is preferable for the mass density to be as uniform as possible within the multilayer structures. This result can be obtained in particular by controlling the variations in the thickness of the interstitial spaces e_{I}. The average controlled thickness of the interstitial spaces is advantageously substantially identical for the N−1 interstitial spaces of the multilayer structure. In one advantageous embodiment of the invention, the variations of e_{I} are lower than 20% and preferably lower than 10%. In the case where ceramic and/or metallic particles serving to space apart the rolled products are placed inside at least one interstitial space, these particles are preferably introduced into each interstitial space.

Furthermore, the present inventors have ascertained that it is preferable for the smallest distance making it possible to pass through the multilayer structure parallel to the layers, i.e., for example the width l_{E} in the case of stacks or the width l_{B} in the case of coils, to be at least equal to a certain value referred to as the threshold value, in order for the nitriding rate to be industrially advantageous. The threshold value is generally 40 mm and preferably 50 mm. In some cases, and in particular if the smallest distance making it possible to pass through the multilayer structure is less than 40 mm, it can be advantageous to wrap the multilayer structures in an aluminium foil.

The present inventors consider that, during the nitriding reaction, one important technical parameter is the diffusion of the nitrogenous atmosphere into the multilayer structure. One of the effects of this diffusion might be the reaction of oxygen molecules present in the nitrogenous atmosphere on the ends of the multilayer structure and their elimination, which is favourable because oxygen is a poison to the nitriding reaction. If the pathway taken by the oxygen molecules via diffusion between the layers is lower than said threshold value, the oxygen elimination phenomenon has probably not taken place sufficiently, which limits and can even prevent the nitriding reaction.

If the mass density of the multilayer structure is too low, the above-described diffusion phenomena are probably insufficient. Furthermore, multilayer structures of low average mass density are difficult to handle. If the average mass density of the multilayer structure is too high, the present inventors have observed that local aluminium melting phenomena due to the heat given off by the nitriding reaction occur and impede the nitriding reaction.

It is possible to use wrought scrap within the scope of the invention, if this makes it possible to produce a multilayer structure in accordance with the invention. The use of wrought scrap is economically beneficial because transformation into aluminium nitride is more cost-effective than recycling through the customary channels.

The rolled aluminium products used within the scope of the invention advantageously contain high-purity aluminium the aluminium content of which is greater than 99.9% by weight. The use of high-purity aluminium thus makes it possible to improve the purity of the aluminium nitride obtained. In one advantageous embodiment, the rolled aluminium products include rolled aluminium-based products having been etched prior to the manufacture of the multilayer structure, i.e., having undergone a chemical and/or electrochemical treatment intended to increase their surface area and/or their roughness. This type of etching treatment is commonly used in the aluminium electrolytic capacitor industry, using high-purity aluminium in particular. An etching treatment is also commonly used in the rolled aluminium products industry for applications related to lithographic processes.

The rolled aluminium products used within the scope of the invention advantageously have a thickness of between 5 and 500 μm and preferably a thickness of between 6 and 200 μm so as to transform the rolled product layers into aluminium nitride in a substantially integral manner.

In a second step, the multilayer structure resulting from the first step is heated under a nitrogenous atmosphere, the thermal heating cycle including at least one phase in which the temperature of the nitrogenous atmosphere is maintained between 400° C. and 660° C., and during the course of which the majority of the nitriding occurs. The heating operation can in particular be carried out in an enclosed oven (batch treatment) or in a suitable continuous passage oven (continuous treatment). The thermal cycle of this heating step can include several phases.

In general, a first phase makes it possible to reach a nitrogenous atmosphere temperature of 400° C. The duration of this phase has little influence on the nitriding rate.

In a second basic phase of the heat treatment, the nitrogenous atmosphere temperature is maintained between 400° C. and 660° C. The majority of the nitriding reaction occurs during this second phase. By majority of the reaction it is understood to mean that more than 50% of the aluminium present has reacted. Thus, in some cases, this invention makes it possible to obtain a nitriding rate greater than 90%, or even greater than 99%, at the end of this second phase. Thus, contrary to one widespread idea, it is not necessary to use a high temperature, e.g., higher than 700° C., in order to obtain a complete nitriding of aluminium products in metal form. The maximum temperature of 660° C. used in the second phase makes it possible to greatly limit the risks of the aluminium melting, which adversely affect the quality of the aluminium nitride obtained. A minimum temperature of 400° C., and preferably 500° C., is necessary in order to initiate the nitriding reaction. The nitriding reaction being highly exothermic, the temperature reached by the aluminium can in some cases exceed the temperature of the nitrogenous atmosphere during the course of this second phase. The duration of this second phase is generally at least equal to 2 hours and preferably at least equal to 5 hours. The optimal duration of this second phase depends on the dimension of the multilayer structures treated. The present inventors have observed that, in some cases, it is advantageous to vary the nitrogenous atmosphere temperature during at least a portion of this second phase, between low points the temperature of which is between 400° C. and 550° C., and high points the temperature of which is between 550° C. and 660° C. A variation is either defined by two low points and one high point or by two high points and one low point. The number of said variations during the course of this second phase is preferably at least equal to 3. These variations seem to make it possible to prevent the nitriding reaction from accelerating uncontrollably. The frequency and duration of the variations must be adapted to the dimension of the samples.

A third phase generally consists in cooling the nitrogenous atmosphere to a temperature sufficiently low enough so that the nitrided samples can be handled.

One or more additional phases can optionally be introduced between the first and second phase. In particular, it may be useful to introduce an additional phase between the second and third phase at a temperature greater than 660° C., possibly reaching approximately 1000° C., for example, so as to further improve the nitriding rate in the event that it is insufficient. This phase, which is economically unfavourable because of the high temperature and the increase in the duration of the operation, is not, however, generally necessary and is therefore preferably avoided. In one advantageous embodiment of the invention, the temperature of the nitrogenous atmosphere does not exceed 660° C. over the entire duration of the heating step.

In one advantageous embodiment of the invention, the temperature of the atmosphere is controlled by a control loop using the temperature measured inside the multilayer structure.

The nitrogenous atmosphere advantageously contains nitrogen in the form of dinitrogen N₂. The nitrogenous atmosphere can also include other gases containing nitrogen such as ammonia NH₃, as well as reducing gases such as dihydrogen H₂, methane CH₄, and more generally hydrocarbonated gases having the generic formula CₓH_{y}, or rare gases such as argon. The nitrogenous atmosphere contains a minimum of oxygen because this element is a poison to the nitriding reaction. Oxygen can in particular be present in the form of dioxygen or water vapour. The controlled diffusion conditions within the scope of the invention make it possible, however, to tolerate an oxygen content in the nitrogenous atmosphere of 50 ppm or even 100 ppm in some cases. The rolled aluminium products are advantageously placed under a vacuum of at least 0.1 bar prior to being placed under a nitrogenous atmosphere. In one preferred embodiment, said nitrogenous atmosphere is swept, with a rate dependent on the oven used. In the case of an enclosed oven, the sweep rate is advantageously between 1 and 10 times the volume of the oven per hour. The lowest sweep rate possible is the most economically advantageous.

This invention makes it possible to directly obtain aluminium nitride wafers the microscopic structure of which is layered. The thickness of these wafers is preferably at least 1 mm and the thickness of the layers is between 5 and 250 μm. The minimum width of the wafers is advantageously 40 mm. This method is very advantageous economically because it avoids the steps for forming the wafers which are obtained from aluminium nitride powder in conventional methods.

In another embodiment, the aluminium nitrides obtained are grinded and optionally sieved, advantageously under a dry inert or reducing atmosphere, so as to obtain an aluminium nitride powder consisting of particles having a size of between 0.5 μm or smaller and 500 μm. When the latter is not very finely grinded, e.g., following grinding to 50 to 500 μm, the aluminium nitride powder according to the invention includes particles in which it is possible to observe that the microscopic structure of the powder is layered, the thickness of the layers being between 5 and 250 μm. This layered structure can in some cases introduce technical advantages to the powder obtained, such as a variation in certain thermal and/or mechanical properties between the direction parallel to the layers and the direction perpendicular to the layers. Powders including particles the microscopic structure of which is layered, which are obtained by the method according to the invention, have the advantage of being capable of being easily grinded in the form of a micronised powder. Thus, from nitrides in coarse form, micronised aluminium nitride powders are obtained the median particle size D50 of which is less than 1 μm, and preferably less than 0.7 μm. Furthermore, the micronised powders according to the invention have a uniform particle-size distribution, the ratio D90/D10 of which is lower than 8 and preferably lower than 6. In one embodiment of the invention, the nitrides are crushed in three steps. In a first step, the nitrided stacks or coils are coarsely crushed so as to obtained pieces having a dimension smaller than 1 cm. In a second step, these pieces are grinded in a ball mill in order to obtain a powder having a median diameter D50 smaller than 500 μm and preferably smaller than 100 μm. A powder is typically obtained the D50 of which is between 50 and 500 μm, including particles in which it is possible to observe that the microscopic structure of the powder is layered. A ball mill is preferably used the jar and balls of which are made of ceramic, in particular zirconia, alumina or preferably aluminium nitride. In a third step, the powders exiting the ball mill are micronised in a fluidised bed air jet mill. In one advantageous embodiment of the invention, the parts in contact with the powder inside the fluidised bed air jet mill are made of ceramic. The grinding operations are advantageously carried out under a dry atmosphere, the dew point of which is lower than 10° C. and preferably lower than 0° C. The present inventors believe that the remarkable qualities of the micronised powder, in terms of diameter and uniformity, can be linked to the layered nature of the microscopic structure, which promotes cleavage.

In the embodiment in which the rolled aluminium products are made of high-purity aluminium, particularly pure aluminium nitride can be obtained, such that the oxygen content is at most 2% by weight and preferably at most 1.5% by weight, the carbon content is lower than 0.03% by weight, and preferably lower than 0.02% by weight, and the percentage of other impurities is lower than 0.01% by weight, and preferably lower than 0.005% by weight.

### Examples

### Example 1

A coil of width l_{B}=39 mm and of a mass density equal to 2.6 g/cm³ was heat-treated at 590° C. for 5 hours under nitrogen. No nitriding was observed.

### Example 2

Sheets of high-purity aluminium (>99.9%) having a thickness of 100 μm, were used for the experimental tests of Example 2. These sheets had been pre-etched so as to reduce their mass density to approximately 2.3 g/cm³.

The experimental nitriding tests were carried out either on stacks of sheets or on coils. The geometric parameters of the stacks are the length L_{E}, the width l_{E} and the thickness e_{E} (FIG. 1). The variations in thickness e_{E} were obtained in particular by placing the stacks under pressure beneath stainless steel plates of various weights. The geometric parameters of the coils are the width l_{B}, the diameter D_{B} and the coiling height h_{B} (FIG. 2). The average mass density of the stack of sheets or of the coil is a useful parameter making it possible to compare the two types of geometry. In the case of the coil, the volume V_{B} considered for calculating the average mass density is

V_{B}=(3.14·(D_{B}²−(D_{B}−2h_{B})²)/4)·l_{B}.

In certain experimental tests, aluminium nitride particles having a length and a width of the order of 1 to 3 mm and a thickness of the order of 100 μm were introduced between the sheets.

The characteristics of the various samples used in the experimental tests are provided in Table 1 below.

TABLE 1
Characteristics of the samples

| | | | | Width | | | |
|---|---|---|---|---|---|---|---|
| | | | Length | l_{E} or | Use of AlN | Average | |
| | | Initial | L_{E} or | Width | particles | mass | Uniformity |
| | | weight | Diameter | l_{B} | between the | density | of the mass |
| Reference | Type | (g) | D_{B} (mm) | (mm) | sheets | (g/cm³) | density* |
| coil 1 | Coil | 2128 | 120 | 120 | No | 2.07 | 3 |
| coil 2 | Coil | 2118 | 120 | 120 | No | 2.09 | 3 |
| batch 1 | Stack | 266 | 295 | 205 | No | 0.35 | 2 |
| batch 5 | Stack | 224 | 295 | 205 | No | 0.35 | 2 |
| batch 9 | Stack | 267 | 295 | 205 | No | 0.35 | 1 |
| batch 14 | Stack | 258 | 295 | 205 | No | 1.85 | 2 |
| batch 15 | Stack | 265 | 295 | 205 | Yes | 1.52 | 3 |
| coil 6 | Coil | 253 | 77 | 109 | No | 0.874 | 2 |
| coil 9 | Coil | 295 | 73 | 260 | No | 0.61 | 2 |
| coil 11 | Coil | 101 | 73 | 121 | No | 0.51 | 2 |
| coil 13 | Coil | 511 | 93 | 240 | Yes | 1.057 | 2 |
| coil 14 | Coil | 665 | 93 | 240 | Yes | 1.167 | 1 |
| coil 16 | Coil | 470 | 93 | 240 | Yes | 1.035 | 2 |
| coil 17 | Coil | 529 | 97 | 240 | Yes | 0.886 | 2 |
| coil 18 | Coil | 677 | 102 | 240 | Yes | 0.897 | 1 |
| coil 19 | Coil | 904 | 104 | 240 | Yes | 1.048 | 2 |
| coil 20 | Coil | 616 | 99 | 240 | Yes | 0.879 | 1 |
| coil 21 | Coil | 810 | 105 | 240 | Yes | 0.796 | 3 |
| coil 22 | Coil | 560 | 93 | 240 | Yes | 1.145 | 2 |
| coil 23 | Coil | 603 | 94 | 240 | Yes | 1.149 | 2 |
| coil 24 | Coil | 807 | 100 | 240 | Yes | 0.979 | 2 |
| coil 25 | Coil | 729 | 100 | 240 | No | 0.554 | 3 |
| coil 28 | Coil | 748 | 105 | 240 | Yes | 0.793 | 2 |
| coil 29 | Coil | 1628 | 122 | 240 | Yes | 0.964 | 3 |
| coil 30 | Coil | 1230 | 116 | 240 | Yes | 0.885 | 3 |
| coil 31 | Coil | 1024 | 11 | 240 | Yes | 0.834 | 3 |
| coil 32 | Coil | 790 | 104 | 250 | Yes | 0.823 | 1 |
| coil 33 | Coil | 886 | 104 | 240 | Yes | 1.027 | 3 |
| coil 34 | Coil | 841 | 97 | 240 | Yes | 1.282 | 3 |
| coil 36 | Coil | 798 | 98 | 240 | Yes | 1.203 | 3 |
| coil 38 | Coil | 1079 | 123 | 240 | Yes | 0.633 | 3 |
| coil 39 | Coil | 720 | 109 | 240 | Yes | 0.659 | 3 |
| coil 40 | Coil | 957 | 110 | 240 | Yes | 0.847 | 2 |
| coil 41 | Coil | 962 | 105 | 240 | Yes | 1.033 | 1 |
| coil 42 | Coil | 968 | 101 | 240 | Yes | 1.247 | 1 |

*1: low. 2: average. 3: satisfactory.

The samples were placed in an oven having a capacity of approximately 1 m³ in which a vacuum of the order of 10⁻² bar was created, into which was then introduced a flow of dinitrogen of the order of 5 Nm³/h, over the entire duration of the experimental test.

Two types of thermal cycles were tested.
C1: Phase 1: heat-up to 400° C. in 0.5 h to 5 h,
   Phase 2: increase in temperature until reaching a value of between 590 and 650° C. The duration of phase 2 is greater than or equal to 2 h.
   Phase 3: cooling down 60° C./h.
C:2 Phase 1: heat-up to 400° C. in 4 to 5 h,
   Phase 2: holding at a temperature greater than 400° C. and less than 660° C. for 6 h. During the course of phase 2, the temperature of the atmosphere varies between low points the temperature of which is between 450° C. and 500° C. and high points the temperature of which is between 550° C. and 650° C., the number of variations being equal to 3.
   Phase 3: cooling down 60° C./h.

The nitriding rate is determined by weighing the samples after experimental testing. A correction is made in the raw result obtained by weighing, on the one hand, in order to take account of the exterior surfaces of the stacks and coils which do not undergo nitriding and, on the other hand, the weight of the AlN particles introduced between the sheets and which do not participate in the reaction. The results obtained are provided in Table 2.

TABLE 2
nitriding rate obtained

| | Thermal | Average mass | Nitriding |
|---|---|---|---|
| Reference | cycle | density (g/cm³) | rate (%) |
| coil 1 | C1 | 2.07 | 10 |
| coil 2 | C1 | 2.09 | 0 |
| batch 1 | C1 | 0.35 | 19 |
| batch 5 | C1 | 0.35 | 21 |
| batch 9 | C1 | 0.35 | 5 |
| batch 14 | C2 | 1.85 | 34 |
| batch 15 | C2 | 1.52 | 70 |
| coil 6 | C2 | 0.874 | 80 |
| coil 9 | C2 | 0.61 | 54 |
| coil 11 | C2 | 0.51 | 48 |
| coil 13 | C2 | 1.057 | 96 |
| coil 14 | C2 | 1.167 | 80 |
| coil 16 | C2 | 1.035 | 90 |
| coil 17 | C2 | 0.886 | 88 |
| coil 18 | C2 | 0.897 | 86 |
| coil 19 | C2 | 1.048 | 90 |
| coil 20 | C2 | 0.879 | 86 |
| coil 21 | C2 | 0.796 | 96 |
| coil 22 | C2 | 1.145 | 95 |
| coil 23 | C2 | 1.149 | 95 |
| coil 24 | C1 | 0.979 | 97 |
| coil 25 | C1 | 0.554 | 100 |
| coil 28 | C1 | 0.793 | 83 |
| coil 29 | C1 | 0.964 | 100 |
| coil 30 | C1 | 0.885 | 100 |
| coil 31 | C1 | 0.834 | 98 |
| coil 32 | C1 | 0.823 | 83 |
| coil 33 | C1 | 1.027 | 100 |
| coil 34 | C1 | 1.282 | 96 |
| coil 36 | C1 | 1.203 | 100 |
| coil 38 | C1 | 0.633 | 94 |
| coil 39 | C1 | 0.659 | 88 |
| coil 40 | C1 | 0.847 | 91 |
| coil 41 | C1 | 1.033 | 80 |
| coil 42 | C1 | 1.247 | 78 |

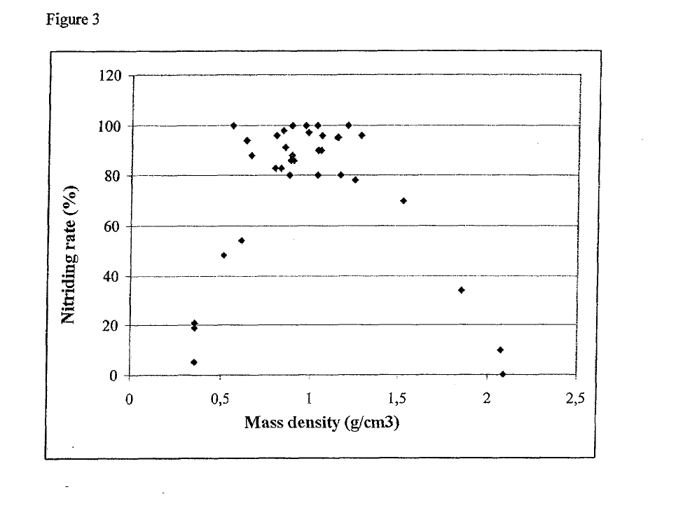

FIG. 3 shows the relationship between the average mass density of the samples and the nitriding rate obtained. An unanticipated and very clear effect of the average mass density on the nitriding rate is observed. For an average mass density lower than or equal to 0.4 g/cm³ or greater than 2 g/cm³, the nitriding rate is very low. Conversely, the nitriding rate attained is more than 50% for mass densities of between 0.6 and 1.3 g/cm³.

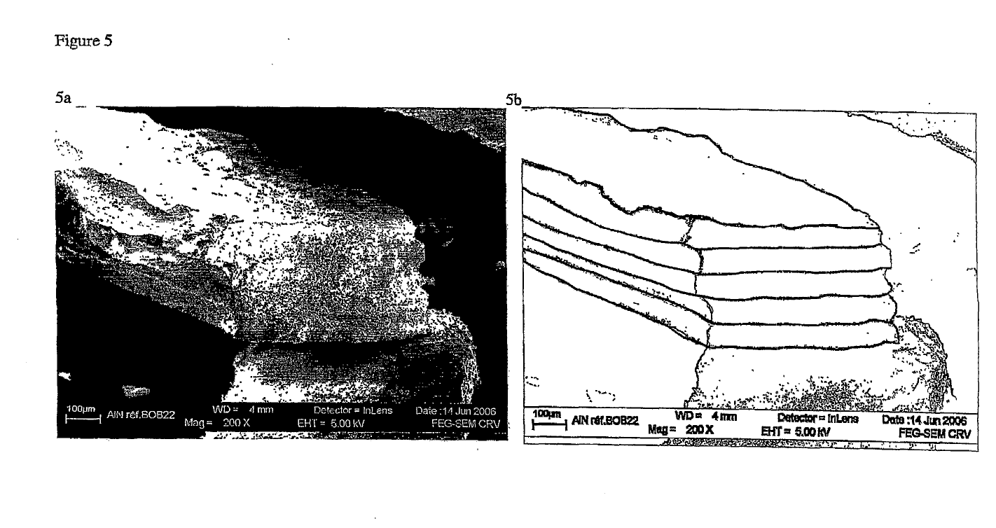

The nitrides obtained were observed via scanning electron microscopy. In FIG. 5a, an AlN particle is observed coming from the sample coil 22. The particle has a thickness of approximately 400 μm, and 5 layers of aluminium nitride are identified having an approximate thickness of 80 μm. This structure has been diagrammed in FIG. 5b.

The nitrides obtained were characterised by chemical and X-ray diffraction analysis.

The specific compositions for the nitrides obtained with the samples coil 13 and coil 9 are provided in Table 3.

TABLE 3
Chemical composition of the aluminium nitride
obtained (% by weight)

| | O | C | Ca | K | Na | Cu | Si | Mg |
|---|---|---|---|---|---|---|---|---|
| Coil | 1.5 | 0.02 | 0.005 | — | — | 0.003 | <0.001 | <0.001 |
| 13 | | | | | | | | |
| Coil 9 | 2.3 | 0.04 | 0.003 | 0.003 | 0.004 | 0.003 | 0.004 | 0.001 |

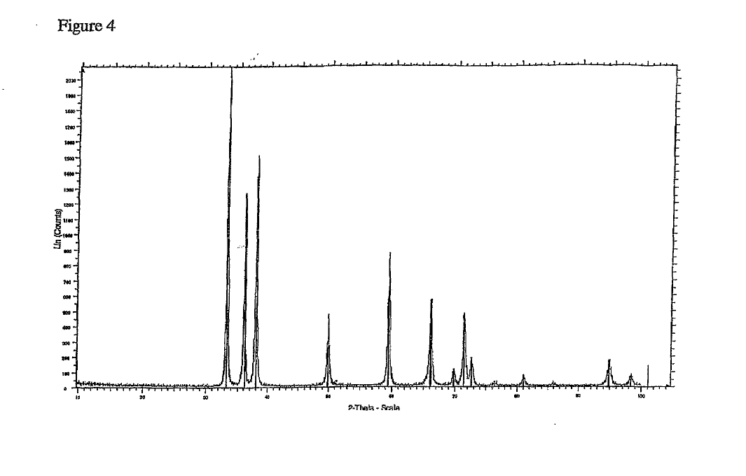

The diffraction spectrum obtained for the sample coil 13 is provided in FIG. 4.

### Example 3

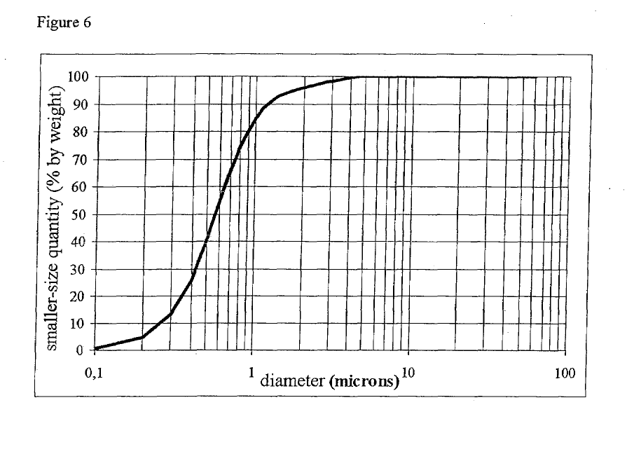

The samples coil 30, coil 31 and coil 33 were grinded so as to obtain nitride pieces having a dimension smaller than 1 cm. These pieces were then grinded in a ball mill the jar and the balls of which are made of ceramic (zirconia and alumina). The pieces were reduced to a powder so as to obtain a median particle size D50 of 31 μm and D90=132 μm. The powders exiting the ball mill were then micronised in a fluidised bed air jet mill made of steel. No particular precaution was taken as concerns the atmosphere used during the grinding steps or during storage of the powders. The particle-size distribution of the powder obtained is presented in FIG. 6. The characteristics of this powder were a D50 value of 0.56 μm, a D10 value of 0.26 μm and a D90 value of 3.47 μm, for a D90/D10 ratio of 4.6.

The micronised powder thus has a D50 value lower than 0.7 μm and a D90/D10 ratio lower than 6, which demonstrates very advantageous degrees of fineness and uniformity.

The composition of the micronised powder obtained is provided in Table 4.

TABLE 4
Chemical composition of the micronised
aluminium nitride obtained (% by weight)

| | Element | | | | | | | | | | |
|---|---|---|---|---|---|---|---|---|---|---|---|
| | O | C | Ca | Na | Cu | Si | Mg | Fe | Cr | Ni | Zr |
| ppm | 4.6 | 0.14 | 0.083 | 0.006 | 0.003 | 0.01 | 0.003 | 0.0063 | 0.0028 | 0.0025 | 0.0093 |

1. Method of manufacturing aluminium nitride in which
(i) a multilayer structure is prepared via stacking or winding, including N layers consisting of aluminium-based rolled products, separated by N−1 interstitial spaces, N being at least equal to 10, the average mass density of the multilayer structure being controlled so as to be between 0.4 and 2 g/cm³, the interstitial spaces being open so as to enable a gas to flow into said interstitial spaces,
(ii) said multilayer structure is heated under a nitrogenous atmosphere, the thermal heating cycle including at least one phase in which the temperature of the nitrogenous atmosphere is maintained between 400° C. and 660° C., and during which the majority of the nitriding occurs.

2. Method of claim 1, in which N is at least equal to 50.

3. Method as claimed in claim 1, in which said multilayer structure is obtained by stacking N layers of rolled products of substantially identical dimensions, each layer being separated from the following one by an interstitial space of controlled average thickness.

4. Method as claimed in claim 1, in which said multilayer structure is obtained by cylindrical winding of a rolled product of substantially constant width in the form of a coil, each layer consisting of a turn and separated from the following one by an interstitial space of controlled average thickness.

5. Method as claimed in claim 3, in which said controlled average thickness in is substantially identical for the N−1 interstitial spaces.

6. Method as claimed in claim 1, in which said average mass density is between 0.6 g/cm³ and 1.8 g/cm³ and preferably between 0.8 g/cm³ and 1.4 g/cm³.

7. Method as claimed in claim 1, in which the thickness of said rolled aluminium product is between 5 and 500 μm, so as to transform said N layers into aluminium nitride, in a substantially integral manner.

8. Method as claimed in claim 1, in which said rolled aluminium-based products include rolled aluminium-based products having been etched.

9. Method as claimed in claim 1, in which said average mass density is controlled by introducing metallic and/or ceramic particles into at least one interstitial space.

10. Method of claim 9, in which said particles include aluminium.

11. Method as claimed in claim 1, in which said nitrogenous atmosphere contains dinitrogen.

12. Method as claimed in claim 1, in which said nitrogenous atmosphere is swept.

13. Method as claimed in claim 1, in which the temperature of the nitrogenous atmosphere does not exceed 660° C. over the entire duration of the heating step.

14. Method as claimed in claim 1, in which the temperature of the nitrogenous atmosphere varies between low points the temperature of which is between 400° C. and 550° C., and high points the temperature of which is between 550° C. and 660° C.

15. Method of claim 14, in which the number of said variations is at least equal to 3.

16. Method as claimed in claim 1, in which the temperature of the atmosphere is controlled by a control loop using the temperature of said multilayer structure.

17. Method as claimed in claim 1, in which the smallest distance making it possible to pass through said multilayer structure parallel to the layers is at least equal to 40 mm.

18. Method as claimed in claim 1, in which the aluminium nitride obtained is grinded.

19. Method of claim 18, in which the grinding is carried out under a dry inert or reducing atmosphere.

20. Method as claimed in claim 1 further comprising grinding the aluminum nitride in three successive steps:
(a) the aluminium nitride is crushed so as to obtain pieces having a dimension smaller than 1 cm,
(b) the pieces thus obtained are grinded in a ball mill so as to obtain a powder having a median diameter of 500 μm,
(c) the powder thus obtained is micronized in a fluidised bed air jet mill.

21. Method as claimed in claim 1, in which said rolled aluminium product contains aluminium the aluminium content of which is greater than 99.9% by weight.

22. Wafer of aluminium nitride obtainable by the method as claimed in claim 1, characterised in that its microscopic structure is layered.

23. Wafer of aluminium nitride of claim 22, the thickness of which is at least equal to 1 mm, in which the thickness of said layers is between 5 and 250 μm.

24. Aluminium nitride powder obtainable by the method as claimed in claim 18, including particles the microscopic structure of which is layered, in which the average particle size is between 50 and 500 μm and in which the thickness of said layers is between 5 and 250 μm.

25. Aluminium nitride powder of claim 24, the oxygen content of which is at most 2% by weight and preferably 1.5% by weight, the carbon content is lower than 0.03% by weight, and preferably lower than 0.02% by weight, and the percentage of other impurities is lower than 0.01% by weight, and preferably lower than 0.005% by weight.

26. Micronised aluminium powder obtainable by the method of claim 20, characterised in that the median particle size D50 is smaller than 1 μm, and preferably smaller than 0.7 μm, and the D90/D10 ratio of which is lower than 8 and preferably lower than 6.
